(19) United States
(12) Patent Application Publication
(10) Pub. No.: US 2026/0298391 A1
(43) Pub. Date: Oct. 1, 2026

(54) HVAC Cap Assembly

(71) Applicant: Joshua Cooley, Queen Creek, AZ (US)

(72) Inventor: Joshua Cooley, Queen Creek, AZ (US)

(21) Appl. No.: 19/630,365

(22) Filed: Mar. 26, 2026

Related U.S. Application Data
(60) Provisional application No. 63/778,988, filed on Mar. 27, 2025.

(51) Int. Cl. F16L 55/115; F25B 41/00

(52) U.S. Cl. CPC F16L 55/1152; F25B 41/00; F25B 2500/221

(57) ABSTRACT

To alert a technician that an HVAC service port is leaking, usually because of a failing Schrader valve, a tamper proof cap assembly is installed. The cap assembly for an HVAC service port has a cylinder that threads onto the service port, and then a piston with an indicator end protrudes when pressure builds up from a leaking service port. A case surrounds the cylinder such that it spins freely about the cylinder, preventing someone without any special tools from removing the cap assembly. The cap assembly can be installed without tools, but a special wrench is needed to remove it.

### CROSS-REFERENCE TO RELATED APPLICATION

This is a non-provisional of U.S. provisional patent application nos. 63/778,988, titled “Coolant Leak Cap System,” filed on Mar. 27, 2025.

### FIELD OF THE INVENTION

The present invention relates to the field of heating ventilation and air conditioning (“HVAC”) equipment and more specifically to an air conditioning service port cap assembly.

### BACKGROUND OF THE INVENTION

Air conditioning systems in homes and buildings usually consist of a compressor and system for holding refrigerant, such as freon, that is under pressure. The air conditioning systems comprise a service port configured to be connected to a gauge set such that a technician can determine the level of refrigerant and fill as needed. Many air conditioning systems include a low side service port and a high side service port, the latter at least being used to make sure that system pressures don't exceed safe levels while adding refrigerant into the low side service port. When not being serviced, threaded dust caps are tightened over a service port to protect seals and keep dirt, dust and water from damaging a service port, but dust caps are not a reliable way to stop a leak at a service port. Dust caps are, unfortunately, able to be removed without the use of special tools. Most service ports are accessible to anyone who can remove a threaded cap, and sometimes service ports develop refrigerant leaks, which can be flammable.

Accordingly, there is a need for a refrigerant cap assembly that is tamper proof and able to detect leaking refrigerant, especially for any of the modern refrigerants that are flammable. The cap assembly is configured to be installed onto an air conditioning service port to provide a tamper proof cap and provide a visual indicator when there is a refrigerant leak at a service port.

Any discussion of prior art throughout the specification should in no way be considered as an admission that such prior art is widely known or forms part of the common general knowledge in the field.

### BRIEF SUMMARY OF THE INVENTION

According to the present invention there is provided an HVAC cap assembly 01 comprising a cylinder 10 comprising a connection end 11 and a drive end 14 with a separator wall 17 between the connection end 11 and the drive end 14, wherein the connection end 11 comprises a threaded portion 12 on an interior wall of the cylinder 10. A piston 20 is configured to press into the cylinder's drive end 14, wherein the piston 20 at least comprises a piston base 21 and a piston rod 25, until the piston base 21 sits against a separator wall 17. Once seated, a piston stop 19 is installed to prevent the piston 20 from blowing out the cylinder's drive end 14. A case 30 encloses the cylinder 10. The case 30 comprises a service port end 31 with a through hole 32 and internal shoulder 33, and a guide end 34 that is capped by a rod guide 40 through which the piston rod 25 advances to indicate there is a leak in the HVAC service port 02, typically because a Schrader valve seal has failed. When the cylinder 10 is removably fixed to the service port 02, the case 30 is able to rotate independently of the cylinder 10.

### BRIEF DESCRIPTION OF THE DRAWINGS

The preferred embodiment of the present invention will now be described, by way of example only, with reference to the accompanying drawings in which:

FIG. 1 shows a perspective view of a cap assembly 01 according to the present disclosure;

FIG. 2 shows an exploded perspective view of the cap assembly 01 according to the present disclosure; and

FIG. 3 shows a series of cut-away views of the cap assembly 01 according to the present disclosure.

FIG. 4 shows a perspective view of the rod guide 40 of the cap assembly 01 according to the present disclosure.

Wherein the callouts in the above Figures contain one or more of the following callouts:
01 cap assembly; 02 service port;
10 cylinder; 11 connection end; 12 threaded portion; 13 o-ring; 14 drive end; 15 plurality of notches; 16 bore; 17 separator wall; 18 relief hole; 19 piston stop;
20 piston; 21 piston base; 22 o-ring; 23 groove; 24 top surface; 25 piston rod; 26 indicator end;
30 case; 31 service port end; 32 through hole; 33 internal shoulder; 34 guide end; 35 ledge;
40 rod guide; 41 outer surface; 42 inner surface; 43 plurality of shaped tabs; 44 spanner holes; 45 aperture;
50 retainer; 51 slot;
60 spanner tool.

### DETAILED DESCRIPTION OF THE INVENTION

The foregoing and other objectives, features, and advantages of the invention will be more readily understood upon consideration of the following description of the invention taken in conjunction with the accompanying drawings.

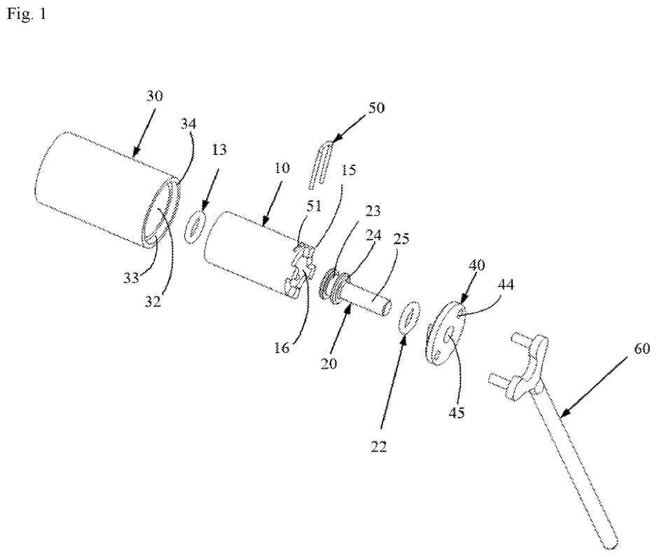

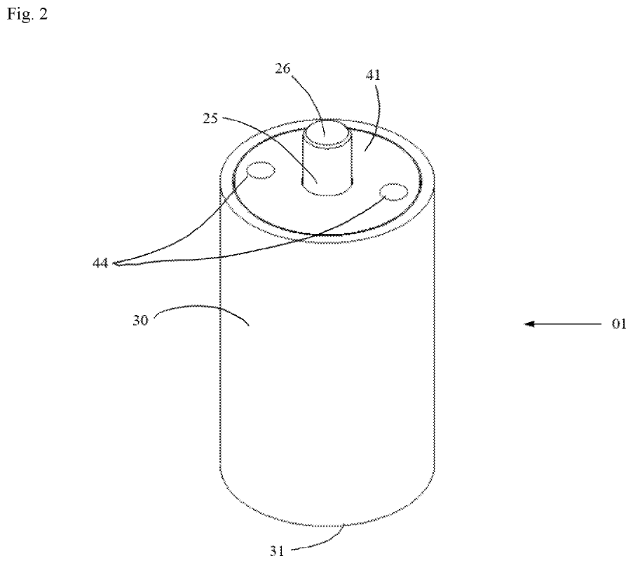

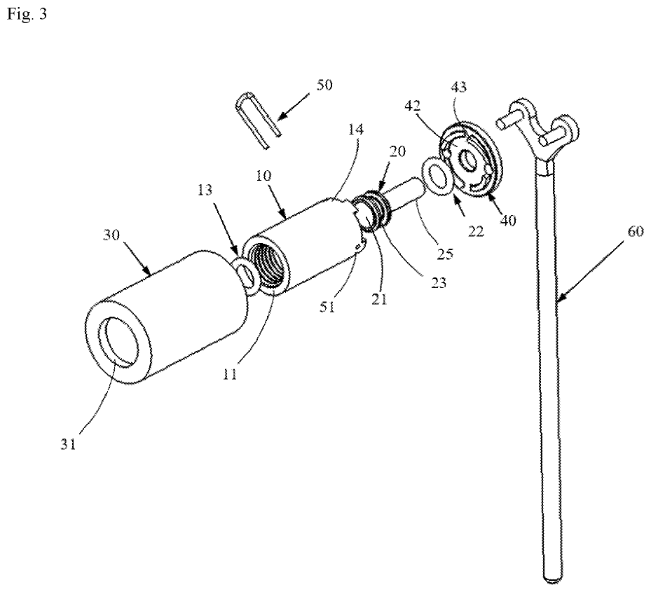

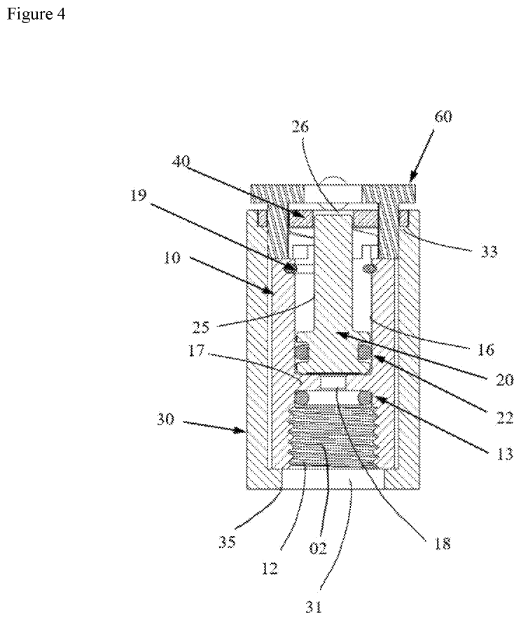

Now referring to the drawings, FIG. 1-4 shows the present invention of a cap assembly 01 comprising a cylinder 10 further comprising a connection end 11 and a drive end 14 opposite the connection end 11 with a separator wall 17 between the connection end 11 and the drive end 14, wherein the connection end 11 comprises a threaded portion 12 on an interior wall. The separator wall 17, which is preferably a disk shaped main-axis cross section of the cylinder 10 and positioned adjacent the deepest thread of the threaded portion 12, has a relief hole 18 which can be any desired size, shape or position, just so long as it's leaky. The relief hole allows refrigerant that leaks from the service port to flow to a piston 20 and build pressure that forces the piston away from the service port 02. The piston 20, characterized by a piston base 21, also has a piston rod 25 extending from it. The piston has a c-shaped groove 23, between the piston base 21 and a top surface 24, that accepts an o-ring 22 that allows the piston to form a seal against the inside of the cylinder 10. Once the o-ring is installed around the piston base, the piston and piston rod are configured to install into the cylinder's drive end 14 until they are fully inside the bore 16, with the piston base 21 substantially seated against the separator wall 17.

Once the piston is installed, a piston stop 19 is installed near the cylinder's drive end 14 to prevent the piston 20 from exiting the bore 16 and breaking through a rod guide 40 if there is a leak that pressurizes cylinder 10 and forces the piston 20 far away from the service port 02. By about 10 psi, the piston should move. The piston stop can be a spring clip, u-clip, pin clip, snap ring or other functionally equivalent retainer. If adequately secured, the rod guide 40 could act as a piston stop 19, noting that a failure could increase the risk of leaking refrigerant to exhaust external to the cap assembly 01. The rod guide 40, of course, is characterized by an aperture 45 through which the piston rod 25 can extend, in which case an indicator end 26 of the piston rod will protrude beyond the rod guide and indicate that pressure exists inside the cylinder 10. The indicator end is preferably a bright color, such as red, to visually indicate that there is a leak that should be fixed, such as by replacing the Schrader valve in the service port.

A case 30, configured to enclose the cylinder 10, comprises a service port end 31 characterized by an internal shoulder 33 that is designed to slip over the service port and loosely seat against the connection end 11 of the cylinder 10. The case also has a through hole 32 into which the entire cylinder 10 fits, connection end 11 first. The rod guide 40 is configured to removably attach to a guide end 34 of the case 30, wherein the rod guide 40 further comprises an aperture 45 for the piston rod 25 to move through. The case 30 rotates independently of the cylinder 10.

The cap assembly 01 is configured to be installed onto a threaded refrigerant service port 02 of an air conditioning system, with an o-ring 13 positioned between the two to prevent leaks. The cap assembly 01 is configured to provide a tamper proof system for preventing human tampering, in addition to blocking outside elements that may damage the service port 02, by allowing the case 30 to rotate freely in either direction about the cylinder 10.

Once the piston 20 is in the cylinder 10 and the cylinder is in the case 30, the rod guide 40 is secured to the guide end 34 of the case using adhesive (which includes epoxy or welding), some sort of retainer, such as an internal snap ring (which would require some sort of ledge or catch at the guide end of the case) or other similar tamper proof retainer. The rod guide 40, which could be described as a cover with a hole through which the indicator end 26 may travel, also comprises two spanner holes 44 on either side of the aperture 45. The rod guide 40 comprises an outer surface 41 and an inner surface 42 wherein the inner surface 42 is characterized by a plurality of shaped tabs 43, extending from the inner surface 42, that only engage a plurality of notches 15 on the drive end 14 of the cylinder 10 when the case is turned in the correct direction, usually clockwise, such that the cap assembly 01 can be threaded onto the service port 02 without the use of any tools, such as a spanner wrench. It may be necessary to push the cap assembly 01 toward the service port 02 to make sure that the plurality of shaped tabs 43 catch the plurality of notches 15 before rotation of the case 30 will cause the cylinder 10 to rotate. The rod guide's 40 inner surface 42 comprises a plurality of shaped tabs 43 extending out from the inner surface 42. The plurality of shaped tabs 43 form a circular pattern and are generally triangular, with a sloped side that won't engage, and a squared side that will engage the plurality of notches 15. However, other shapes not included herein may be considered, and the case does not need to be cylindrical, nor does the rod guide need to be a disc shape, although that is preferred.

The rod guide 40 further comprises one or more, preferably two, spanner holes 44. The spanner holes 44 are configured to accept a specialized tool, such as a spanner wrench 60, to be inserted into the spanner holes 44 such that the spanner tool 60 can reach through the rod guide 40 and engage the plurality of notches 15 so that the cylinder 10 can be rotated counter clockwise and removed from the service port 02. Multiple rotations of the cap assembly 01 using the spanner wrench 60 should remove cap assembly 01 from the service port 02.

Although the present invention has been described by way of example, it should be appreciated that variations and modifications may be made without departing from the scope of the invention. By example, a spring may be added between the piston's top surface 24 and the piston stop 19 to prevent relatively low refrigerant pressures from moving the indicator end 26 away from the service port 02. Variations in required pressure for actuation of the piston 20 could be offered, such as a 10 psi cap assembly, a 50 psi cap assembly, or even a 300 psi cap assembly. The spring selected would determine the refrigerant pressure needed to force the piston 20 away from the service port 02. It is noted that if one of the o-rings 15,22 or other selected sealing method used in the cap assembly fails, then the cap assembly will leak and the spring will push the piston 20 back toward the service port 02, giving a false reading that there is no leak. To overcome this problem, the indicator end 26 could detach from the reset of the piston rod 25, such as by having the indicator end be a pin inside a sleeve portion of the piston rod, said pin separating from the sleeve portion if the piston is pushed by the spring back toward the service port. Furthermore, where known equivalents exist to specific features, such equivalents are incorporated as if specifically referred to in this specification.

What is claimed is:

1. A cap assembly, for an HVAC service port, comprising:
a cylinder comprising a drive end, and a connection end with a threaded portion that is threaded onto a service port, wherein a separator wall with a relief hole lies between the connection end and the drive end;
a piston, positioned inside a bore of the cylinder and against the separator wall, comprising a piston base and a top surface, with an o-ring fitted into a c-shaped groove between the piston base and top surface for making a seal between the piston and an inside of the cylinder;
a piston rod attached to the top surface of the piston and characterized by an indicator end;
a case configured to house the cylinder, wherein the case comprises a service port end with a through hole and internal shoulder, and a guide end through which the indicator end will protrude if a refrigerant builds pressure and pushes the piston away from the service port;
a rod guide that is fixed to the guide end such that the case encases the cylinder.

2. The cap assembly of claim 1 further comprising a piston stop at the drive end.

3. The cap assembly of claim 2 wherein the piston stop is a retainer.

4. The cap assembly of claim 3 wherein the retainer is a retaining ring.

5. The cap assembly of claim 1 further comprising a plurality of notches at the drive end, and a plurality of shaped tabs on an inner surface of the rod guide; and wherein, when the case is turned clockwise, the plurality of shaped tabs engages with the plurality of notches such that the threaded portion is screwed onto the service port.

6. The cap assembly of claim 5 further comprising at least one spanner wrench hole in the rod guide, and wherein a spanner wrench that is pressed into the spanner wrench hole until the spanner wrench engages with at least one of the plurality of notches engages such that the cylinder can be rotated counter-clockwise and removed from the service port.

7. The cap assembly of claim 2 wherein the piston stop is a u-clip that clips around at least one slot located near the drive end.

8. The cap assembly of claim 1 further comprising an o-ring between the service port and the separator wall.

9. The cap assembly of claim 1 wherein the separator wall is adjacent a termination of the threaded portion.

10. The cap assembly of claim 1 wherein a top surface of the rod guide is secured to the case using adhesive.

11. The cap assembly of claim 1 wherein a top surface of the rod guide is secured to the case using a tamper proof retainer.

12. The cap assembly of claim 1 wherein the rod guide is characterized by an aperture through which the indicator end may protrude.

13. The cap assembly of claim 1 further comprising a spring between the top surface and the rod guide.

14. The cap assembly of claim 13 wherein the spring selected has a spring force that opposes at least 10 psi of pressure applied against the piston.

15. The cap assembly of claim 14 wherein the spring force is at least 50 psi.

16. The cap assembly of claim 14 wherein the spring force is at least 200 psi.

17. The cap assembly of claim 13 wherein the rod has a sleeve portion, and the indicator end is substantially a pin portion that at least partially slides inside the sleeve portion, and wherein the indicator end stays extended out of the rod guide even if the piston moves back toward the service port.
